(19) United States
(12) Patent Application Publication
(10) Pub. No.: US 2025/0008429 A1
(43) Pub. Date: Jan. 2, 2025

(54) TECHNIQUES FOR REDUCING POWER CONSUMPTION IN A BASE STATION

(71) Applicant: CommScope Technologies LLC, Claremont, NC (US)

(72) Inventor: Harsha Hegde, Buffalo Grove, IL (US)

(73) Assignee: CommScope Technologies LLC, Claremont, NC (US)

(21) Appl. No.: 18/661,209

(22) Filed: May 10, 2024

Related U.S. Application Data
(60) Provisional application No. 63/511,275, filed on Jun. 30, 2023.

(51) Int. Cl. H04W 52/02; H04W 16/18; H04W 24/02

(52) U.S. Cl. CPC H04W 52/0206; H04W 16/18; H04W 24/02

(57) ABSTRACT

Techniques are disclosed for using a model and data to determine adjustments, e.g., reductions, of power consumption, e.g., component(s), of a base station utilizing an older or optionally a newer RAT, and even when to decommission a base station utilizing the older RAT.

### CROSS-REFERENCE TO RELATED APPLICATIONS

The present application claims benefit of U.S. Patent Application Ser. No. 63/511,275 filed Jun. 30, 2023; the entire contents of the aforementioned patent application are incorporated herein by reference as if set forth in its entirety.

### BACKGROUND

As base stations with new radio access technologies (RAT), e.g., 5G New Radio (NR), are deployed, base stations employing older RATs, e.g., 4G Long Term Evolution (LTE), are typically maintained. That is, for a given coverage area, a network operator typically operates both a 5G RAT base station and a 4G RAT base station. This ensures continuity of service for users who have not yet upgraded their user equipment (UE) to a UE configured to use a 5G RAT and continue to use a UE configured utilize a 4G RAT but not the 5G RAT. Continued operation of base stations employing older RATs is typically undesirably since it can increase a network operator's operating expenses (including expenses arising from maintenance of and electrical power consumption by such older RAT base stations).

### SUMMARY OF THE INVENTION

In some aspects, the techniques described herein relate to a method for adjusting electrical power consumption of at least one of a first RAT base station utilizing a newer RAT and a second RAT base station utilizing an older RAT, wherein the newer RAT is different than the older RAT, and wherein the first and the second RAT base stations have a common coverage area, the method including: determining first data indicative of providing wireless service in the common coverage area using one or more base stations matching at least one of the first RAT base station and the second RAT base station; determining a model using the first data and data generated by or obtained from at least one of the first RAT base station and the second RAT base station, to determine a change of operation of at least one component of at least one of the first RAT base station and the second RAT base station that alters electrical power consumption of the at least one component; receiving a second data from at least one of the first RAT base station and the second RAT base station; determining, using the second data and the model, a respective alteration of electrical power consumption of, at least one component of at least one of the first RAT base station and the second RAT base station; and adjusting the electrical power consumption of said at least one component in accordance with the determined alteration.

In some aspects, the techniques described herein relate to a non-transitory computer readable medium storing a program causing at least one processor to execute a process to adjust electrical power consumption of at least one of a first RAT base station utilizing a newer RAT and a second RAT base station utilizing an older RAT, wherein the newer RAT is different than the older RAT, and wherein the first and the second RAT base stations have a common coverage area, the process including: determining first data indicative of providing wireless service in the common coverage area using one or more base stations matching at least one of the first RAT base station and the second RAT base station; determining a model using the first data and data generated by or obtained from at least one of the first RAT base station and the second RAT base station, to determine a change of operation of at least one component of at least one of the first RAT base station and the second RAT base station that alters electrical power consumption of the at least one component; receiving a second data from at least one of the first RAT base station and the second RAT base station; determining, using the second data and the model, a respective alteration of electrical power consumption of at least one component of at least one of the first RAT base station and the second RAT base station; and adjusting the electrical power consumption of said at least one component in accordance with the determined alteration.

In some aspects, the techniques described herein relate to an apparatus for adjusting electrical power consumption of at least one of a first RAT base station utilizing a newer RAT and a second RAT base station utilizing an older RAT, wherein the newer RAT is newer than the older RAT, and wherein the first and the second RAT base stations have a common coverage area, the apparatus including: processing circuitry configured to: determine first data indicative of providing wireless service in the common coverage area using one or more base stations matching at least one of the first RAT base station and the second RAT base station; determine a model using the first data and data generated by or obtained from at least one of the first RAT base station and the second RAT base station, to determine a change of operation of at least one component of at least one of the first RAT base station and the second RAT base station that alters electrical power consumption of the at least one component; receive a second data from at least one of the first RAT base station and the second RAT base station; determine, using the second data and the model, a respective alteration of electrical power consumption of at least one component of at least one of the first RAT base station and the second RAT base station; and adjust the electrical power consumption of said at least one component in accordance with the determined alteration.

### BRIEF DESCRIPTION OF THE DRAWINGS

Comprehension of embodiments of the techniques disclosed here is facilitated by reading the following detailed description in conjunction with the annexed drawings, in which:

FIG. 1 illustrates a block diagram of one embodiment of a communications system 100 configured to utilize a first RAT and a second RAT; and

FIG. 2 illustrates a flow diagram of one embodiment of a method to diminish power consumption of a base station.

### DETAILED DESCRIPTION

Techniques are disclosed for determining adjustments, e.g., reductions, of power consumption, e.g., of component(s), of a base station utilizing an older or optionally a newer RAT¹, and even when to decommission a base station utilizing the older RAT. In some embodiments, when both a base station using a newer RAT and a base station using an older RAT provide cellular coverage in a common coverage area², the following is undertaken. A model is created which is configured to determine (a) power adjustment, e.g., reduction, of component(s) of a base station utilizing the older RAT and/or optionally the newer RAT, and (b) optionally when the RAN utilizing the older RAT can be decommissioned, and thus powered down and optionally removed. Optionally temporarily reducing electrical power consumption in all or part of the newer RAT base station may be desirable if there relatively low traffic using the newer RAT, e.g., in a rural geographic region and/or if there are only sensors, e.g., electric utility meters, which periodically and infrequently transmit data using the newer RAT. ¹Typically, a newer RAT will have a higher maximum data rate than an older RAT.²The base station with the older RAT and the base station with the new RAT may or may not be part of the same radio access network (RAN).

Once the model is created, the model is further configured to receive, e.g., periodically or aperiodically, data pertaining to operation of the older RAT base station and optionally data pertaining to operation of the newer RAT base station. Elements of the data pertaining to the older RAT base station may be received by or generated by the older RAT base station. Elements of the optional data pertaining to the newer RAT base station may be received by or generated by the newer RAT base station.

The model utilizes each data to determine whether power can be reduced to all or part of the corresponding RAT, or whether the RAT base station utilizing the older RAT can be decommissioned. Optionally, the model may be updated, e.g., periodically, or aperiodically, using one or more of each data pertaining to operation of the older RAT base station, and optionally using one or more of each data pertaining to operation of the older RAT base station.

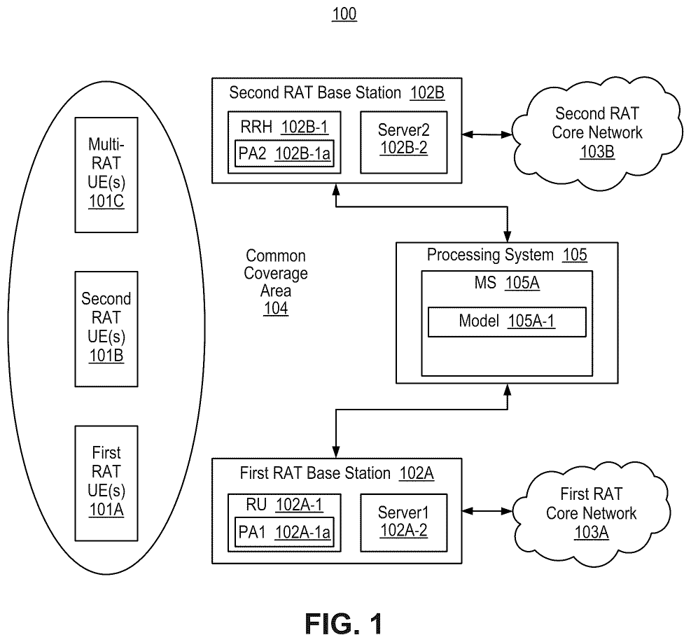

FIG. 1 illustrates a block diagram of one embodiment of a communications system 100 configured to utilize a first RAT and a second RAT. The first RAT is a newer RAT, e.g., 5G NR, and the second RAT is an older RAT, e.g., 4G LTE. The communications system 100 includes a first RAT base station 102A, a second RAT base station 102B, a first RAT core network 103A, a second RAT core network 103B, and a processing system (or processing system circuitry) 105. The first RAT base station 102A is a base station configured to operate using the first RAT. The second RAT base station 102B is a base station configured to operate using the second RAT. Depending on the RAT, a RAT base station may include a remote radio head (RRH) and a baseband unit (BBU) (e.g., for 4G LTE), a radio unit (RU), a distributed unit (DU), and a central unit (e.g., for 5G NR), or any other configuration. Some components of a RAT base station (e.g., BBU(s), DU(s), and/or CU(s)) may be implemented in physical and/or virtual server(s), e.g., in a cloud computing system. Each server may have more than one physical or virtual processor core which is configured to be enable or disabled. Each RAT base station 102A, 102B includes at least one radio unit 102A-1 or remote radio head 102B-1 and optionally at least one server 102A-2, 102B-2; however, a server 102A-1, 102B-1 may be located external to a RAT base station, e.g., and may be or part of a cloud computing system. Each radio unit 102A-1 and each remote radio head 102B-1 includes at least one power amplifier (PA) 102A-la, 102B-la.

Each of the first RAT core network 103A and the second RAT core network 103B are configured to facilitate high speed communications between a RAN including a base station and an external network, and to provide, e.g., mobility and session management for user equipment, and/or a quality of service function. Each RAT base station 102A, 102B is communicatively coupled to a corresponding RAT core network 103A, 103B. Thus, the first RAT base station 102A is communicatively coupled to the first RAT core network 103A, and the second RAT base station 102B is communicatively coupled to the second RAT core network 103B. Each base station is a logical entity implemented in a corresponding RAN. Optionally, the core networks 103A, 103B are implemented with shared physical and/or virtual components, e.g., server(s), backhaul communication system(s), etc.

Each of the first RAT base station 102A and the second RAT base station 102B have a coverage area in which communications may be facilitated with user equipment (UE). The coverage areas may not be the same. However, there will be a common coverage area 104 where there is an overlap of a coverage area of the first RAT base station 102A and a coverage area of the second RAT base station 102B.

UE configured to operate using the first RAT (first RAT UE) 101A, and, e.g., in the common coverage area 104, may communicate with the first RAT base station 102A. UE configured to operate using the second RAT (second RAT UE) 101B, and, e.g., in the common coverage area 104, may communicate with the second RAT base station 102B. UE configured to operate using either the first or the second RAT (multi-RAT UE) 101C, and, e.g., in the common coverage area 104, may communicate with either the first or second RAT base station 102A, 102B.

The processing system 105 is communicatively coupled to each RAT base station, and is configured to control components in each RAT base station, e.g., to reduce electrical power consumption by a RAT base station. The processing system 105 is external to each pair of RAT base station and RAT core network. For pedagogical purposes, the processing system 105 is illustrated as being external to each pair of RAT base station and RAT core network; however, the processing system 105 may be part of one or both RAT base stations.

Optionally, the processing system 105 includes and executes a management system (MS) 105A used to manage each pair of RAT base station and RAT core network end to end, e.g., RRHs, RUs, BBU(s), DU(s), CU(s), and/or core network(s). The management system 105A is aware of a hierarchical structure of each pair of RAT base station and RAT core network, including without limitation each RRH or RU in a RAT base station and each RAT core network.

The management system 105A includes the model 105A-1 described herein, collects information from each RAT base station, collects data which are the independent variable(s) of the model, executes the model, and affects power reduction actions in at least one RAT base station. Optionally, the management system 105A creates and/or modifies such model 105A-1. Alternatively, the model may be created and/or modified on another processing system. Optionally, the management system 105A may be a non-real time RAN intelligent controller (RIC), e.g., with an R1 interface, in an O-RAN architecture³, and the model 105A-1 may be implemented as RAN automation application (rApp) in the non-real time RIC. Thus, optionally, the first set and the second data may be provisioned through the R1 interface to generate the model 105A-1 in an rApp using machine learning. ³The O-RAN Alliance publishes various specifications for implementing radio access networks (RANs) in an open manner. “O-RAN” is an acronym that also stands for “Open RAN.” but in this description references to “O-RAN” should be understood to be referring to the O-RAN Alliance, one or more specifications published by the O-RAN Alliance, and/or entities or interfaces implemented in accordance with one or more specifications published by the O-RAN Alliance.

The model determines discrete power states of the first RAT base station 102A or components thereof, and optionally of the second RAT base station 102B. The model 105A-1 may be (a) a deterministic model created using machine learning and/or by human derivation or (b) artificial intelligence, e.g., a neural network, created by machine learning. The deterministic model may be a function of parameters⁴ (for example, key performance indicators of a RAT base station) which are obtained or generated by the RAT base station. Optionally, the model includes a threshold level and/or a weighting for one or more of the parameters. A parameter value, e.g., downlink traffic throughput, is compared, e.g., to ascertain if it is greater than or less than, a parameter threshold level, e.g., downlink traffic throughput threshold level. The model may optionally include a second parameter threshold level to facilitate hysteresis so that the model does not cause a component of the RAT base station to rapidly alternate between an unreduced power state and a reduced power state. ⁴Parameters may include without limitation a number of UE attached to a RAT base station, location(s) of such attached UE (e.g., based on UE downlink measurements reported by the attached UE), and/or an amount of traffic conveyed in an uplink path and/or downlink path between the UE and the RAT base station (“traffic throughput in an uplink path and/or downlink path).

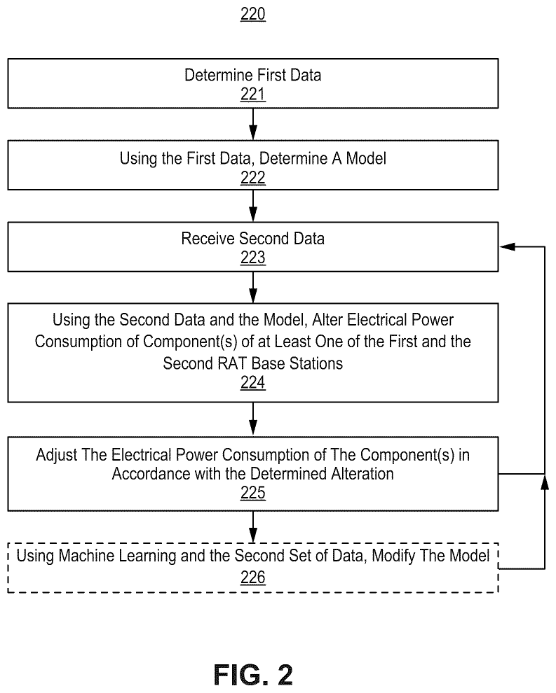

Optionally, the model 105A-1 may be implemented and executed as described with respect to FIG. 2. Optionally, the processing system 105 is implemented using virtual machine(s), state machine(s), and/or a neural network(s); the processing system 105 may be implemented with server(s) or cloud computing system(s).

FIG. 2 illustrates a flow diagram of one embodiment of a method 220 to diminish power consumption of a base station. To the extent that the methods shown in any Figures are described herein as being implemented with the apparatuses illustrated herein, e.g., in FIG. 1, it is to be understood that other embodiments can be implemented in other ways. The blocks of the flow diagrams have been arranged in a generally sequential manner for ease of explanation; however, it is to be understood that this arrangement is merely exemplary, and it should be recognized that the processing associated with the methods (and the blocks shown in the Figures) can occur in a different order (for example, where at least some of the processing associated with the blocks is performed in parallel and/or in an event-driven manner).

In block 221, first data is determined, e.g., by the processing system 105 or another processing system. The term “determined” also means obtained, received, and generated.

The first data may be data that is generated and/or obtained by the first RAT base station and/or optionally the second RAT base station. Alternatively, the first data may be data that is neither generated nor obtained by the first RAT base station nor by the second RAT base station, but rather is historical data generated by and/or obtained by one or more base stations each of which has a coverage area that as a same characteristic as the common coverage area. For example, such coverage area(s) may be in a geographic region with a same terrain morphology (e.g., rural, urban, suburban, indoor, etc.) as a geographic location of a common coverage area of the first and the second RAT base stations.

The first data may optionally include base station usage data, user equipment (UE) data (e.g., type of modulation coding scheme, precoding matrix indicator, and/or control channel report), number of (UE) (configured to operate using either the first or the second RAT) which are connected to one of the RAT base stations and/or are predicted to be connected to one of the RAT base stations⁵. In a standalone RAN the first or second RAT base station may be able to detect if a UE connected to it can operate on the other RAT base station based on the operating bands of the UE. ⁵In a non-standalone RAN, e.g., when the first RAT base station 102A uses a 5G RAT and the second RAT base station 102B uses a 4G LTE RAT, user plane communications are between the UE and the first RAT base station 102A and control plane communications are between the UE and the second RAT base station 102B. In such a non-standalone RAN, the second RAT base station 102B has information about UEs connected to both the first and the second RAT base stations for user plane communications. Thus, optionally, the processing system 105, e.g., the management system 105A, e.g., the model 105A-1, may be able to obtain some or all of a second data set about the first RAT base station 102A from the second RAT base station 102B. For example, the second RAT base station 102B would be aware of the UE configured to operate with both the first or the second RATs and connected to the first RAT base station 102A.

In block 222, using the first data, a model is determined. The model is configured to determine (a) whether, e.g., if and when, and how to reduce or increase, e.g., temporarily,⁶ power consumption of the RAT base station employing the older RAT, e.g., the first RAT base station, (b) optionally whether, e.g., if and when, to decommission the RAT base station employing the older RAT, and (c) optionally whether, e.g., if and when to temporarily reduce power consumption of the RAT base station employing the newer RAT, e.g., the second RAT base station. When determining that power consumption of a RAT base station should be reduced or increased, the model identifies components⁷ of a RAT base station, e.g., RRHs or RUs, power amplifier(s) of each such RRH or RU, and/or core(s) of server(s) used to implement the RAT base station (e.g., of the BBU, DU, and/or CU) whose operation may be affected to obtain a change, e.g., reduction or increase, of power consumption. For example, such server(s) may perform baseband processing. ⁶When electrical power of a RAT base station (and thus component(s) thereof) is temporarily reduced, this necessitates subsequently determining when electrical power of the RAT base station (and thus the component(s) thereof) should be increased. However, some power reductions, e.g., decommissioning, are permanent.⁷All or a subset of components of a RAT base station are subject to power consumption control.

In block 223, a second data is received from the first RAT base station and/or from the second RAT base station. The second data may include some or all of the data described above for the first data and is based on recent temporal activity by and/or with the corresponding RAT base station. The second data may be actual data at a point in time or for a period of time which is generated or obtained by a RAT base station, and/or may be predicted data for the point in or period of time.

In block 224, using the second data and the model, a respective alteration of electrical power consumption of at least one component of at least one of the first RAT base station and the second RAT base station is determined or identified. Such component(s) include (a) power amplifier(s) (of RRH(s) or RU(s) of a RAT base station) and/or (b) server(s), one or more cores of such server(s), e.g., implementing baseband processing, for the RAT base station, and/or the process(es) (i.e., software) executed thereon. However, the component(s) may include other constituent elements of a RAT base station. Such alteration may be, for example, decreasing or increasing (a) electrical power provided to, or drawn by a component, (b) a parameter of a component, e.g., gain of a power amplifier, a RU, or an RRU, and/or (c) enabling or disabling operation of all or a portion of the component, e.g., a server or a processor core of a server, e.g., used to implement baseband processing for a RAT base station. Optionally, power consumption can be reduced, e.g., to zero, by terminating operation of a component, e.g., a core. In block 225, the electrical power consumption of said at least one component is adjusted in accordance with the determined alteration.

In the event it is determined that a RAT base station is to be decommissioned, then the components of the RAT base station is to be decommission is determined. Optionally, components of the RAT base station and corresponding modes of operation thereof are also determined.

If a RAT base station is determined to be decommissioned, i.e., permanently, then such operational changes are perpetually affected, e.g., including through subsequent the RAT base station disassembly and removal. Further, all components, which can so be affected, are powered off. In the event a RAT base station is to be decommissioned, then optionally a message, e.g., an email, is sent to a network operator which operates the RAT base station identified to be decommissioned.

In optional block 226, using machine learning (ML), the second data is used to modify the model. After block 225 or optional block 226, proceed to block 223.

The processing system may optionally including processor(s) or processor circuitry coupled to memories (or memory circuitry). The processor circuitry described herein may include one or more microprocessors, microcontrollers, digital signal processing (DSP) elements, application-specific integrated circuits (ASICs), and/or field programmable gate arrays (FPGAs). In this exemplary embodiment, processor circuitry includes or functions with software programs, firmware, or other computer readable instructions for carrying out various process tasks, calculations, and control functions, used in the methods described herein. These instructions are typically tangibly embodied on any storage media (or computer readable medium) used for storage of computer readable instructions or data structures.

The memory circuitry described herein can be implemented with any available storage media (or computer readable medium) that can be accessed by a general purpose or special purpose computer or processor, or any programmable logic device. Suitable computer readable medium may include storage or memory media such as semiconductor, magnetic, and/or optical media. For example, computer readable media may include conventional hard disks, Compact Disk-Read Only Memory (CD-ROM), DVDs, volatile or non-volatile media such as Random Access Memory (RAM) (including, but not limited to, Dynamic Random Access Memory (DRAM)), Read Only Memory (ROM), Electrically Erasable Programmable ROM (EEPROM), and/or flash memory. Combinations of the above are also included within the scope of computer readable media.

Methods of the invention can be implemented in computer readable instructions, such as program modules or applications, which may be stored in the computer readable medium that is part of (optionally the memory circuitry) or communicatively coupled to the processing circuitry, and executed by the processing circuitry, optionally the processor circuitry. Generally, program modules or applications include routines, programs, objects, data components, data structures, algorithms, and the like, which perform particular tasks or implement particular abstract data types.

### Exemplary Embodiments

Example 1 includes a method for adjusting electrical power consumption of at least one of a first RAT base station utilizing a newer RAT and a second RAT base station utilizing an older RAT, wherein the newer RAT is different than the older RAT, and wherein the first and the second RAT base stations have a common coverage area, the method comprising: determining first data indicative of providing wireless service in the common coverage area using one or more base stations matching at least one of the first RAT base station and the second RAT base station; determining a model using the first data and data generated by or obtained from at least one of the first RAT base station and the second RAT base station, to determine a change of operation of at least one component of at least one of the first RAT base station and the second RAT base station that alters electrical power consumption of the at least one component; receiving a second data from at least one of the first RAT base station and the second RAT base station; determining, using the second data and the model, a respective alteration of electrical power consumption of, at least one component of at least one of the first RAT base station and the second RAT base station; and adjusting the electrical power consumption of said at least one component in accordance with the determined alteration.
Example 2 includes the method of Example 1, wherein the first data comprise data determined for providing wireless service in the common coverage area using the first RAT base station and the second RAT base station.
Example 3 includes the method of any of Examples 1-2, wherein the first data comprise data determined for providing wireless service in one or more coverage areas other than the common coverage area.
Example 4 includes the method of Example 3, wherein the one or more coverage areas other than the common coverage area have a characteristic that matches a characteristic associated with the common coverage area.
Example 5 includes the method of any of Examples 1-4, wherein the model is determined by machine learning.
Example 6 includes the method of any of Examples 1-5, further comprising using the second data, modifying the model with machine learning.
Example 7 includes the method of any of Examples 1-6, wherein adjusting the electrical power consumption of each said at least one component temporarily decreases or increases the electrical power consumption of each said at least one determined component.
Example 8 includes the method of any of Examples 1-7, further comprising, using the model, determining whether to decommission the first RAT base station; wherein adjusting the electrical power consumption of at least one component of the first RAT base station permanently decreases the electrical power consumption of each component of the first RAT base station.
Example 9 includes the method of Example 8, further comprises transmitting a message to a network operator controlling the first RAT base station and stating that the first RAT base station is decommissioned.
Example 10 includes the method of any of Examples 1-9, wherein the at least one component includes a power amplifier, a server, a core of a server, or software executed by the server.
Example 11 includes the method of any of Examples 1-10, wherein the model is implemented in a radio access network (RAN) automation application (rApp).
Example 12 includes a non-transitory computer readable medium storing a program causing at least one processor to execute a process to adjust electrical power consumption of at least one of a first RAT base station utilizing a newer RAT and a second RAT base station utilizing an older RAT, wherein the newer RAT is different than the older RAT, and wherein the first and the second RAT base stations have a common coverage area, the process comprising: determining first data indicative of providing wireless service in the common coverage area using one or more base stations matching at least one of the first RAT base station and the second RAT base station; determining a model using the first data and data generated by or obtained from at least one of the first RAT base station and the second RAT base station, to determine a change of operation of at least one component of at least one of the first RAT base station and the second RAT base station that alters electrical power consumption of the at least one component; receiving a second data from at least one of the first RAT base station and the second RAT base station; determining, using the second data and the model, a respective alteration of electrical power consumption of at least one component of at least one of the first RAT base station and the second RAT base station; and adjusting the electrical power consumption of said at least one component in accordance with the determined alteration.
Example 13 includes the non-transitory computer readable medium of Example 12, wherein the first data comprise data determined for providing wireless service in the common coverage area using the first RAT base station and the second RAT base station.
Example 14 includes the non-transitory computer readable medium of any of Examples 12-13, wherein the first data comprise data determined for providing wireless service in one or more coverage areas other than the common coverage area.
Example 15 includes the non-transitory computer readable medium of any of Examples 12-14, wherein the one or more coverage areas other than the common coverage area have a characteristic that matches a characteristic associated with the common coverage area.
Example 16 includes the non-transitory computer readable medium of any of Examples 12-15, wherein the model is determined by machine learning.
Example 17 includes the non-transitory computer readable medium of any of Examples 12-16, wherein the process further comprises using machine learning and the second data, modifying the model.
Example 18 includes the non-transitory computer readable medium of any of Examples 12-17, wherein adjusting the electrical power consumption of each said at least one component temporarily decreases or increases the electrical power consumption of each said at least one determined component.
Example 19 includes the non-transitory computer readable medium of any of Examples 12-18, wherein the process further comprises, using the model, determining whether to decommission the first RAT base station; wherein adjusting the electrical power consumption of at least one component of the first RAT base station permanently decreases the electrical power consumption of each component of the first RAT base station permanently decreases the electrical power consumption of each component of the first RAT base station.
Example 20 includes the non-transitory computer readable medium of Example 19, wherein the process further comprises causing transmission of a message to a network operator controlling the first RAT base station and stating that the first RAT base station is decommissioned.
Example 21 includes the non-transitory computer readable medium of any of Examples 12-20, wherein the model is implemented in a radio access network (RAN) automation application (rApp).
Example 22 includes an apparatus for adjusting electrical power consumption of at least one of a first RAT base station utilizing a newer RAT and a second RAT base station utilizing an older RAT, wherein the newer RAT is newer than the older RAT, and wherein the first and the second RAT base stations have a common coverage area, the apparatus comprising: processing circuitry configured to: determine first data indicative of providing wireless service in the common coverage area using one or more base stations matching at least one of the first RAT base station and the second RAT base station; determine a model using the first data and data generated by or obtained from at least one of the first RAT base station and the second RAT base station, to determine a change of operation of at least one component of at least one of the first RAT base station and the second RAT base station that alters electrical power consumption of the at least one component; receive a second data from at least one of the first RAT base station and the second RAT base station; determine, using the second data and the model, a respective alteration of electrical power consumption of at least one component of at least one of the first RAT base station and the second RAT base station; and adjust the electrical power consumption of said at least one component in accordance with the determined alteration.
Example 23 includes the apparatus of Example 22, wherein the first data comprise data determined for providing wireless service in the common coverage area using the first RAT base station and the second RAT base station.
Example 24 includes the apparatus of any of Examples 22-23, wherein the first data comprise data determined for providing wireless service in one or more coverage areas other than the common coverage area.
Example 25 includes the apparatus of Example 24, wherein the one or more coverage areas other than the common coverage area have a characteristic that matches a characteristic associated with the common coverage area.
Example 26 includes the apparatus of any of Examples 22-25, wherein the model is determined by machine learning.
Example 27 includes the apparatus of any of Examples 22-26, wherein the processing circuitry is further configured to, using machine learning and the second data, modify the model.
Example 28 includes the apparatus of any of Examples 22-27, wherein adjust the electrical power consumption of each said at least one component temporarily decreases or increases the electrical power consumption of each said at least one determined component.
Example 29 includes the apparatus of any of Examples 22-28, wherein the processing circuitry is further configured to, using the model, determine whether to decommission the first RAT base station; wherein adjusting the electrical power consumption of at least one component of the first RAT base station permanently decreases the electrical power consumption of each component of the first RAT base station.
Example 30 includes the apparatus of Example 29, wherein the processing circuitry is further configured to cause transmission of a message to a network operator controlling the first RAT base station and stating that the first RAT base station is decommissioned.
Example 31 includes the apparatus of any of Examples 22-30, wherein the at least one component includes a power amplifier, a server, a core of a server, or software executed by the server.
Example 32 includes the apparatus of any of Examples 22-31, further comprising: the first RAT base station; and the second RAT base station; wherein each of the first and the second RAT base station are communicatively coupled to the processing circuitry.
Example 33 includes the apparatus of any of Examples 22-32, wherein the model is implemented in a radio access network (RAN) automation application (rApp).

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

What is claimed:

1. A method for adjusting electrical power consumption of at least one of a first RAT base station utilizing a newer RAT and a second RAT base station utilizing an older RAT, wherein the newer RAT is different than the older RAT, and wherein the first and the second RAT base stations have a common coverage area, the method comprising:
determining first data indicative of providing wireless service in the common coverage area using one or more base stations matching at least one of the first RAT base station and the second RAT base station;
determining a model using the first data and data generated by or obtained from at least one of the first RAT base station and the second RAT base station, to determine a change of operation of at least one component of at least one of the first RAT base station and the second RAT base station that alters electrical power consumption of the at least one component;
receiving a second data from at least one of the first RAT base station and the second RAT base station;
determining, using the second data and the model, a respective alteration of electrical power consumption of, at least one component of at least one of the first RAT base station and the second RAT base station; and
adjusting the electrical power consumption of said at least one component in accordance with the determined alteration.

2. The method of claim 1, wherein the first data comprise data determined for providing wireless service in the common coverage area using the first RAT base station and the second RAT base station.

3. The method of claim 1, wherein the first data comprise data determined for providing wireless service in one or more coverage areas other than the common coverage area.

4. The method of claim 3, wherein the one or more coverage areas other than the common coverage area have a characteristic that matches a characteristic associated with the common coverage area.

5. The method of claim 1, wherein the model is determined by machine learning.

6. The method of claim 1, further comprising using the second data, modifying the model with machine learning.

7. The method of claim 1, wherein adjusting the electrical power consumption of each said at least one component temporarily decreases or increases the electrical power consumption of each said at least one determined component.

8. The method of claim 1, further comprising, using the model, determining whether to decommission the first RAT base station;
wherein adjusting the electrical power consumption of at least one component of the first RAT base station permanently decreases the electrical power consumption of each component of the first RAT base station.

9. The method of claim 8, further comprises transmitting a message to a network operator controlling the first RAT base station and stating that the first RAT base station is decommissioned.

10. The method of claim 1, wherein the at least one component includes a power amplifier, a server, a core of a server, or software executed by the server.

11. The method of claim 1, wherein the model is implemented in a radio access network (RAN) automation application (rApp).

12. A non-transitory computer readable medium storing a program causing at least one processor to execute a process to adjust electrical power consumption of at least one of a first RAT base station utilizing a newer RAT and a second RAT base station utilizing an older RAT, wherein the newer RAT is different than the older RAT, and wherein the first and the second RAT base stations have a common coverage area, the process comprising:
determining first data indicative of providing wireless service in the common coverage area using one or more base stations matching at least one of the first RAT base station and the second RAT base station;
determining a model using the first data and data generated by or obtained from at least one of the first RAT base station and the second RAT base station, to determine a change of operation of at least one component of at least one of the first RAT base station and the second RAT base station that alters electrical power consumption of the at least one component;
receiving a second data from at least one of the first RAT base station and the second RAT base station;
determining, using the second data and the model, a respective alteration of electrical power consumption of at least one component of at least one of the first RAT base station and the second RAT base station; and
adjusting the electrical power consumption of said at least one component in accordance with the determined alteration.

13. The non-transitory computer readable medium of claim 12, wherein the first data comprise data determined for providing wireless service in the common coverage area using the first RAT base station and the second RAT base station.

14. The non-transitory computer readable medium of claim 12, wherein the first data comprise data determined for providing wireless service in one or more coverage areas other than the common coverage area.

15. The non-transitory computer readable medium of claim 12, wherein the one or more coverage areas other than the common coverage area have a characteristic that matches a characteristic associated with the common coverage area.

16. The non-transitory computer readable medium of claim 12, wherein the model is determined by machine learning.

17. The non-transitory computer readable medium of claim 12, wherein the process further comprises using machine learning and the second data, modifying the model.

18. The non-transitory computer readable medium of claim 12, wherein adjusting the electrical power consumption of each said at least one component temporarily decreases or increases the electrical power consumption of each said at least one determined component.

19. The non-transitory computer readable medium of claim 12, wherein the process further comprises, using the model, determining whether to decommission the first RAT base station;
wherein adjusting the electrical power consumption of at least one component of the first RAT base station permanently decreases the electrical power consumption of each component of the first RAT base station permanently decreases the electrical power consumption of each component of the first RAT base station.

20. The non-transitory computer readable medium of claim 19, wherein the process further comprises causing transmission of a message to a network operator controlling the first RAT base station and stating that the first RAT base station is decommissioned.

21. The non-transitory computer readable medium of claim 12, wherein the model is implemented in a radio access network (RAN) automation application (rApp).

22. An apparatus for adjusting electrical power consumption of at least one of a first RAT base station utilizing a newer RAT and a second RAT base station utilizing an older RAT, wherein the newer RAT is newer than the older RAT, and wherein the first and the second RAT base stations have a common coverage area, the apparatus comprising: processing circuitry configured to:
determine first data indicative of providing wireless service in the common coverage area using one or more base stations matching at least one of the first RAT base station and the second RAT base station;
determine a model using the first data and data generated by or obtained from at least one of the first RAT base station and the second RAT base station, to determine a change of operation of at least one component of at least one of the first RAT base station and the second RAT base station that alters electrical power consumption of the at least one component;
receive a second data from at least one of the first RAT base station and the second RAT base station;
determine, using the second data and the model, a respective alteration of electrical power consumption of at least one component of at least one of the first RAT base station and the second RAT base station; and
adjust the electrical power consumption of said at least one component in accordance with the determined alteration.

23. The apparatus of claim 22, wherein the first data comprise data determined for providing wireless service in the common coverage area using the first RAT base station and the second RAT base station.

24. The apparatus of claim 22, wherein the first data comprise data determined for providing wireless service in one or more coverage areas other than the common coverage area.

25. The apparatus of claim 24, wherein the one or more coverage areas other than the common coverage area have a characteristic that matches a characteristic associated with the common coverage area.

26. The apparatus of claim 22, wherein the model is determined by machine learning.

27. The apparatus of claim 22, wherein the processing circuitry is further configured to, using machine learning and the second data, modify the model.

28. The apparatus of claim 22, wherein adjust the electrical power consumption of each said at least one component temporarily decreases or increases the electrical power consumption of each said at least one determined component.

29. The apparatus of claim 22, wherein the processing circuitry is further configured to, using the model, determine whether to decommission the first RAT base station;
wherein adjusting the electrical power consumption of at least one component of the first RAT base station permanently decreases the electrical power consumption of each component of the first RAT base station.

30. The apparatus of claim 29, wherein the processing circuitry is further configured to cause transmission of a message to a network operator controlling the first RAT base station and stating that the first RAT base station is decommissioned.

31. The apparatus of claim 22, wherein the at least one component includes a power amplifier, a server, a core of a server, or software executed by the server.

32. The apparatus of claim 22, further comprising:
the first RAT base station; and
the second RAT base station;
wherein each of the first and the second RAT base station are communicatively coupled to the processing circuitry.

33. The apparatus of claim 22, wherein the model is implemented in a radio access network (RAN) automation application (rApp).
